(19) United States
(12) Patent Application Publication
(10) Pub. No.: US 2012/0240407 A1
(43) Pub. Date: Sep. 27, 2012

(54) URETHANE ISOLATION MOUNT AND METHOD OF MOUNTING FOR VEHICLE DIFFERENTIALS

(76) Inventor: Asa Von Sudderth, Las Vegas, NV (US)

(21) Appl. No.: 13/428,908

(22) Filed: Mar. 23, 2012

Related U.S. Application Data
(60) Provisional application No. 61/467,586, filed on Mar. 25, 2011.

(51) Int. Cl. F16F 7/00; B23P 11/00; F16M 13/02

(52) U.S. Cl. 29/897.2; 248/634

(57) ABSTRACT

A urethane isolation mount secures a vehicle's differential while dampening or isolating noise, vibration, and movement between the differential and the remainder of the vehicle. The urethane isolation mount may comprise one or more resilient urethane materials. The urethane isolation mount may also have an opening to accept a support stem of the differential. The opening may have a wider bore and a narrower bore to provide a step to which a fastener may secure the support stem to the urethane isolation mount. The urethane isolation mount provides increased reliability and greatly reduces, if not eliminates, repair costs for replacement differential mounts when installed.

### CROSS-REFERENCE TO RELATED APPLICATION

This application claims priority to U.S. Provisional Patent Application No. 61/467,586, titled Urethane Isolation Mount and Method of Mounting for Vehicle Differentials, filed Mar. 25, 2011.

### BACKGROUND OF THE INVENTION

1. Field of the Invention

The invention relates to isolation mounts, particularly to an isolation mount and mounting method for vehicle differentials.

2. Related Art

Virtually every car and truck utilizes a differential to transmit power from its engine to its wheels. Early on, a vehicle's differential would be directly mounted to the vehicle's frame. Though this secured the differential to the vehicle, such direct and rigid mounting serves as a conduit for vibration and noise to travel to the vehicle's passenger compartment.

Today, differentials are typically mounted with dampening systems that reduce vibration. The replacement of these dampening systems is a costly and time consuming process and unfortunately occurs all too often.

From the discussion that follows, it will become apparent that the present invention addresses the deficiencies associated with the prior art while providing numerous additional advantages and benefits not contemplated or possible with prior art constructions.

### SUMMARY OF THE INVENTION

A urethane isolation mount is disclosed herein. In general, the urethane isolation mount may be used to secure a differential to a subframe or other portion of a vehicle. The urethane isolation mount isolates the vehicle from noise, vibration, and movement occurring at the differential. This is highly advantageous in that it greatly increases the comfort and desirability of the vehicle. As will be described further below, the urethane isolation mount is also rugged and reliable compared to traditional mounts. This increases vehicle reliability while greatly reducing, if not eliminating, expensive repair costs for mount replacement/repair.

The urethane isolation mount may have a variety of configurations. For example, in one embodiment a urethane isolation mount for securing a differential to a subframe of a vehicle is provided. Such a urethane isolation mount may comprise a cylindrical body consisting of a resilient urethane material. The cylindrical body may have a front end and a back end and a diameter matching the diameter of an opening in the subframe. A beveled edge may be at the front end of the cylindrical body. For instance, the beveled edge may be at the periphery of the cylindrical body. It is noted that the cylindrical body may comprise at least a first and a second type of resilient urethane material of different hardnesss.

An opening may be in the cylindrical body. The opening may be configured to accept a support stem extending from the differential, and comprise a first bore and a second bore and a step therebetween, wherein the first bore has a narrower width than the second bore. The first bore of the opening may have a diameter matching the diameter of the support stem extending from the differential. It is noted that a threaded fastener having a diameter larger than the diameter of the first bore may be provided. Alternatively or in addition, the first bore may be threaded to accept one or more threads of the support stem of the differential. The second bore of the opening may have a diameter at least as large as the diameter of the threaded fastener. The opening may extend from the front end to the back end of the cylindrical body and may be centrally located on the cylindrical body.

It is also noted that an insert configured to contact an interior portion of the cylindrical body to cause the cylindrical body to expand may be in the opening. The insert may be rigid, be in the larger or smaller bore of the opening, or both. The insert may transfer force to an interior portion of the cylindrical body to cause the cylindrical body to expand. Such expansion causes the cylindrical body to contact/engage the opening of a subframe and thus secures the cylindrical body to the subframe.

In another exemplary embodiment, a urethane isolation mount assembly for securing a vehicle differential may be provided. The urethane isolation mount assembly may comprise a first resilient urethane material having a cylindrical shape (having a front end and a back end), and an opening configured to accept a support stem of the vehicle differential and extending from the front end to the back end of the first resilient urethane material. The opening may comprise a first bore and a second bore and a step therebetween. The first bore and the second bore may have different diameters. It is noted that a rigid sleeve may line the opening in the first resilient urethane material.

A threaded fastener having an inner diameter to accept a threaded portion of the support stem and an outer diameter less than the diameter of the second bore may be included as part of the assembly to secure the support stem to the first resilient urethane material. In addition or alternatively, the opening in the first resilient urethane material may be threaded to accept/secure a threaded portion of the support stem of the vehicle differential.

The urethane isolation mount assembly may include a vehicle subframe having an opening to accept the resilient urethane material. The opening of the subframe may have a diameter matching a peripheral diameter of the first resilient urethane material to accept the first resilient urethane material.

A second resilient urethane material having a cylindrical shape may be added. The second resilient urethane material may have a central opening to accept the first resilient material therein. The central opening may have a diameter matching a peripheral diameter of the first resilient urethane material. The first resilient urethane material may be harder than the second resilient urethane material.

Various methods of securing a vehicle differential to a vehicle subframe are disclosed as well. A method of securing a vehicle differential to a subframe with a urethane isolation mount may comprise locating an opening in the subframe located at a rear end of a vehicle and adjacent the vehicle differential, inserting a urethane isolation mount having a central opening and an outer diameter matching a diameter of the opening in the subframe into the opening of the subframe, and inserting a support stem of the vehicle differential into the central opening. The support stem may extend beyond a first bore and into a second wider bore of the central opening.

The urethane isolation mount may be inserted while the subframe is attached to a vehicle. An obstruction, if any, may be removed from the opening in the subframe before inserting the urethane isolation mount. This may occur in various ways. For example, a receiver cup may be positioned at a first side of the subframe at the opening and a presser plate may be positioned at a second side of the subframe, also at the opening. The presser plate may be moved through the opening and towards the receiver cup by rotating a connecting rod that is between the presser plate and the receiver cup. In this way, the presser plate may push the obstruction out of the opening, and in some cases into the receiver cup where it can be contained.

A fastener may be inserted into the second wider bore of the central opening, and the support stem may be attached to the urethane isolation mount by securing the to fastener to the support stem such that the fastener presses against a step of the central opening located between the first bore and the second wider bore. It is noted that the method may include forming the first bore and the second wider bore in the urethane isolation mount. The urethane isolation mount may be formed from a first resilient urethane material and a second resilient urethane material, wherein the first and second resilient urethane materials have distinct hardness.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

The components in the figures are not necessarily to scale, emphasis instead being placed upon illustrating the principles of the invention. In the figures, like reference numerals designate corresponding parts throughout the different views.

FIG. 1 is a top view of a vehicle drive train having a differential secured by an exemplary urethane isolation mount;

FIG. 2A is a perspective view of an exemplary urethane isolation mount;

FIG. 2B is a front view of an exemplary urethane isolation mount;

FIG. 2C is a back view of an exemplary urethane isolation mount;

FIG. 3A is a front view of an exemplary vehicle subframe having an exemplary urethane isolation mount;

FIG. 3B is a front view of an exemplary vehicle subframe having an exemplary urethane isolation mount;

FIG. 3C is a side view of an exemplary vehicle having a differential secured by an exemplary urethane isolation mount;

FIG. 3D is a perspective view of an exemplary differential support stem secured to an exemplary urethane isolation mount;

FIG. 4A is a cross section view of an exemplary urethane isolation mount comprising two urethane materials;

FIG. 4B is a cross section view of an exemplary urethane isolation mount comprising two urethane materials;

FIG. 4C is a cross section view of an exemplary urethane isolation mount comprising a threaded opening;

FIG. 5A is a cross section view of an exemplary urethane isolation mount and insert;

FIG. 5B is a cross section view of an exemplary urethane isolation mount and insert being secured within a subframe opening;

FIG. 5C is a cross section view of an exemplary urethane isolation mount and insert expanded within a subframe opening;

FIG. 5D is a perspective view of an exemplary urethane isolation mount and insert; and

FIG. 6 is a perspective view of an obstruction removal tool.

### DETAILED DESCRIPTION OF THE PREFERRED EMBODIMENTS

In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

In general, the urethane isolation mount secures one vehicle component to another while isolating the components from movement, sound, and vibration occurring at the other component. As discussed herein, the urethane isolation mount can be used to secure a differential to a vehicle's frame or other supporting structure. The vibration, sound, and movement isolation provided by the urethane isolation mount is highly beneficial with regard to a vehicle's differential because the differential is a source of substantial noise and vibration. Without isolation, this noise and vibration would be transmitted to the passenger compartment and significantly interfere with the driver's and any passenger(s)' quiet enjoyment of the vehicle. This is especially so given that the vehicle's body may function as an echo or resonance chamber for noise emanating from the differential. In addition, the vibration may, over time, weaken other portions of the vehicle leading to annoying rattles or the like, or even damage to the vehicle.

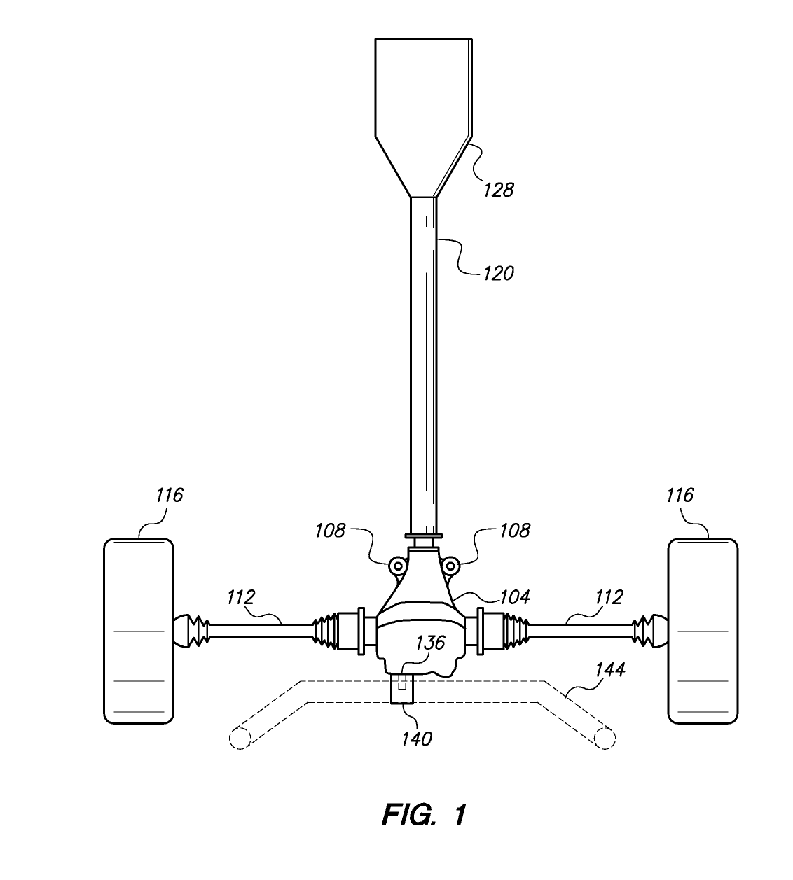

The isolation mount 140 will now be described with regard to FIG. 1. FIG. 1 is a top view of drive components of an exemplary vehicle. As can be seen, these drive components include a transmission 128, drive shaft 120, and differential 104. The differential 104 may be used to transfer power to the vehicle's wheels 116, such as via a wheel drive shaft 112.

The urethane isolation mount 140 may secure the differential 104 to a support, subframe 144 or frame of the vehicle, such as shown in FIG. 1. As can be seen, the urethane isolation mount 140 may be located between a subframe 144 and the differential 104. In this manner, the urethane isolation mount 140 may absorb noise and vibration and prevent it from spreading from the differential 140 to the subframe 144 and/or frame of the vehicle. In one or more embodiments, the urethane isolation mount 140 may accept and hold a portion of the differential 104. For instance, in FIG. 1, the urethane isolation mount 140 has been configured to accept a support stem 136 extending outward from the differential 104.

The urethane isolation mount 140 may work in conjunction with one or more rubber mounts 108 to secure the differential 104. The rubber mounts 108 may be at the front of the differential 104 while the urethane isolation mount 140 may be at the rear. The rubber mounts 108 may be oriented horizontally with their openings oriented vertically, such as shown. This is beneficial in that the differential 104 compresses and tends to place strain on the mounts in a vertical direction. Thus, the horizontally oriented rubber mounts 108 have a long life since the strain is spread along their bodies.

In FIG. 1, the rubber mounts 108 and urethane isolation mount 140 form a triangle mounting arrangement. Though this is a strong mounting arrangement, it can be seen that the urethane isolation mount 140 is mounted at a different orientation than the rubber mounts 108. Namely, the urethane isolation mount 140 has its opening at a horizontal orientation to accept the horizontally extending stem 136 of the differential 104. This places the opening of the urethane isolation mount 140 under great strain. This is because the stem 136 is held in position by the isolation mount 140. Thus, all movement of the stem 136 would need to be absorbed by the urethane isolation mount 140. As will be discussed further below, the urethane isolation mount 140 is configured to accept such strain without damage.

An isolation mount of a different material would likely tear or be damaged. In fact, rubber mounts have been shown to tear, leak silicone, or otherwise fail well before the end of life of a vehicle. Upon failure, torsional control of the differential can no longer be controlled by the isolation mount. Drivers and passengers will notice this as wheel hop, excessive vibration/shaking, and increased noise.

The cost of repair for a torn or damaged rubber mount is high. This is especially so given that manufacturers may only sell a new rubber mount as part of a vehicle's subframe. This is because the rubber mount may be pressed into the subframe at the time of manufacture. In addition, existing rubber mounts may comprise a liquid silicon filing held by outer walls of the rubber mounts. Such a configuration is easy to puncture especially when the rubber mount must be press fit into a subframe. Thus, to repair a damaged rubber mount, a new subframe would typically have to be purchased and labor costs would be incurred in replacing the old subframe with the new subframe. Such repair can cost between $500-1500. This is cost prohibitive especially when considering the cost of a new rubber mount would be a fraction of the repair cost.

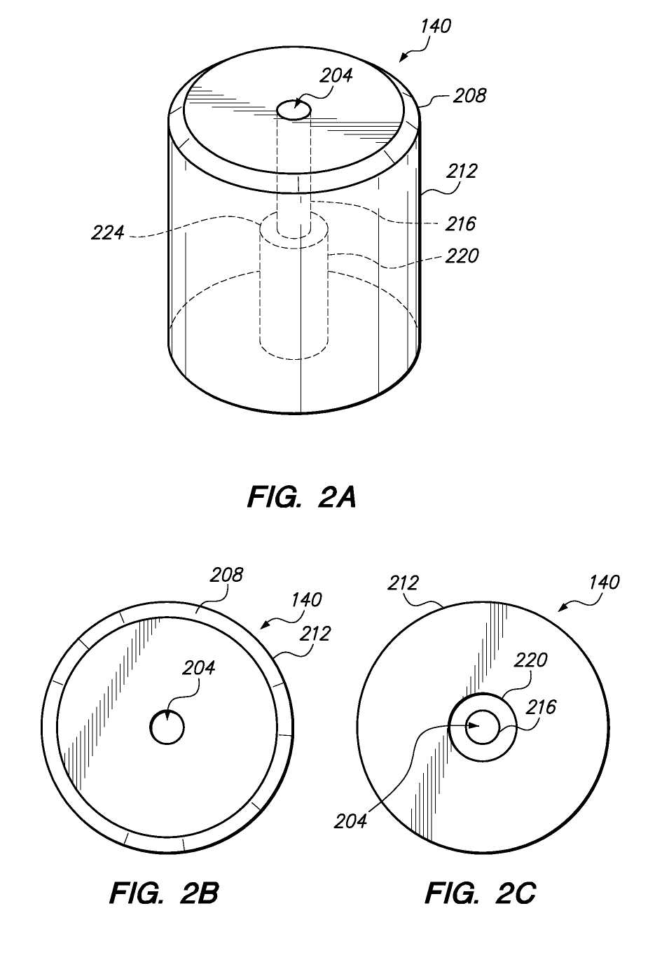

FIGS. 2A-2C illustrate various views of an exemplary urethane isolation mount 140. FIG. 2A provides a perspective view while FIGS. 2B-2C respective provide a front and back view of the urethane isolation mount 140. As can be seen, the urethane isolation mount 140 may comprise a cylindrical body 212 having one or more openings 204. In one or more embodiments, the urethane isolation mount 140 may have one or more surface features to allow it to conform to a surface of a vehicle's subframe or other structure. For example, the urethane isolation mount's body 212 may have a bevel 208 at one or both ends. It is contemplated that the body 212 may have one or more ridges, protrusions, indentations or the like as well in some embodiments.

The opening 204 of the urethane isolation mount 140 may be configured to accept a stem of a vehicle's differential, such as described above. In one or more embodiments, the opening 204 may be centrally located so as to provide an equal amount of material between the opening 204 and the outer surface of the body 212. This allows the urethane isolation mount 140 to provide consistent isolation of the differential's stem and thus the differential itself in all directions.

As can be seen, the opening 204 may have a stepped configuration in one or more embodiments. For instance, as shown in FIGS. 2A and 2C, the opening has a narrower bore 216 and a wider bore 220 with a shelf or stepped portion 224 in between. The wider bore 220 may be configured to accept a fastener, such as a nut, that may be threaded onto the stem of the differential which protrudes through the narrower bore 216 and at least a portion into the wider bore 220. The stepped portion 224 may provide a surface which may bear or support the fastener as it is tightened or secured to the differential's stem.

As its name suggests, the urethane isolation mount 140 may be manufactured from urethane. This is highly advantageous in that urethane is a durable, yet flexible material. Due to these characteristics, the urethane isolation mount 140 can secure a differential to a vehicle while also dampening or isolating the vehicle from noise, vibration, and movement of the differential.

Traditionally, rubber mounts have been used, as discussed above. Rubber, though pliant, is not as durable as urethane and is known to become brittle, crack, or break over time. This is highly undesirable especially where, as here, repairs to a rubber mount would be difficult, time consuming, and costly. In addition, rubber itself may not be sufficient to provide the desired dampening characteristics. In fact, traditional rubber mounts filled with silicon have been used to address this issue. This however, leads to problems since the rubber shell or skin of a mount can and does break. The silicon then leaks out of the mount causing the mount to lose most, if not all, of its dampening properties. In addition, once the silicon leaks from the mount, the mount can no longer securely hold a differential in position. Also, as stated above, silicon filled mounts are fragile and thus are typically press-fit to vehicle subframes at the time of manufacture. With at least some vehicles, it is impossible to purchase a replacement silicon filled mount, and thus repair must occur by replacing an entire subframe of the vehicle (even though the subframe itself is not defective or damaged).

In contrast, the urethane isolation mount 140 may comprise a solid urethane body 212 that cannot leak and is rugged. This allows the urethane isolation mount 140 to be installed at non-factory locations and allows the urethane isolation mount to be installed without replacing or removing a vehicle's subframe. For example, a auto shop, dealer, or virtually any skilled mechanic may install the urethane isolation Filing Date: March 23, 2012 PATENT mount. This is, in part, because care does not need to be taken to avoid puncturing or damaging the urethane isolation mount 140. In addition, since the urethane body 212 of the urethane isolation mount 140 is a solid structure, it may be pressed or pushed into position (or otherwise inserted) with a variety of tools. It is even possible to use impact force, such as by a mallet or the like to install the urethane isolation mount 140. This is, at the very least, not recommended or impossible with rubber or silicon filed mounts.

Moreover, the urethane isolation mount 140 may be installed at the time of manufacture of the subframe or vehicle. In this manner, a new vehicle or subframe would have the benefit of the urethane isolation mount 140. This is highly advantageous to consumers because it greatly increases the reliability of the vehicle and decreases maintenance costs. For instance, it is generally known when a silicon filled or other rubber mount will fail. Cost cutting has resulted in rubber mounts of such quality that they are known to fail well before the life of the vehicle. Thus, the repair costs for a broken rubber mount are, in essence, built into the cost of the vehicle (even though deferred for several years). As is known, reliability is very important to vehicle manufacturers.

With the urethane isolation mount 140, this repair cost is at the very least further delayed. In most cases, the repair cost would be eliminated due to the reliable construction of the urethane isolation mount 140. Namely, in one or more embodiments, the urethane isolation mount 140 may comprise a solid urethane body 212 shaped as shown in FIGS. 2A-2C. It is contemplated that various portions or sections of the body 212 may be formed from various densities or types of urethane, such as to provide different levels of noise, vibration, and/or movement dampening/isolation.

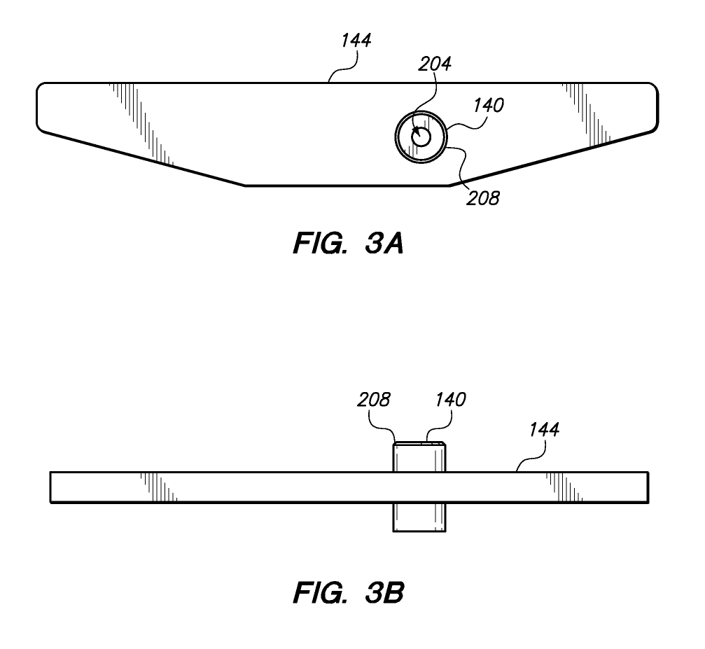

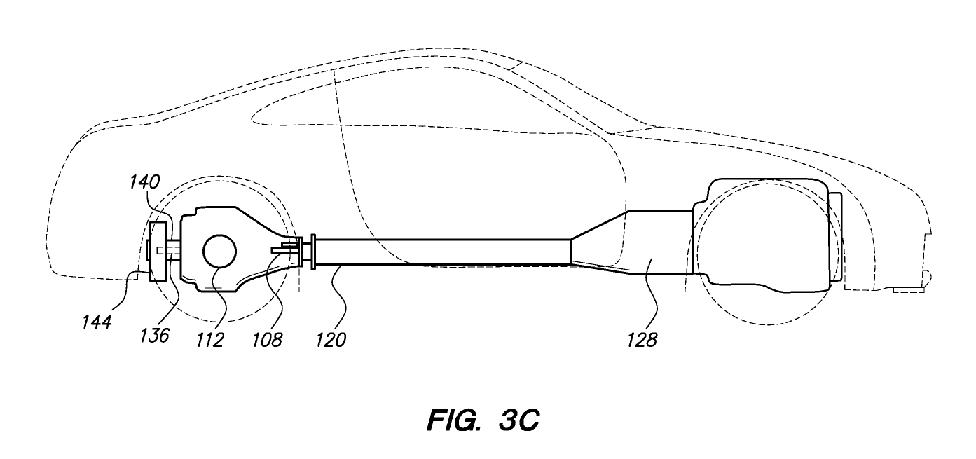

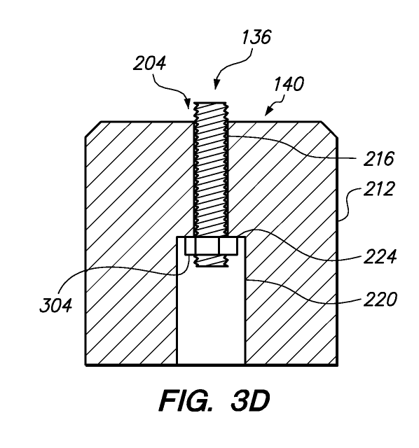

Installation of the urethane isolation mount 140 will now be described with regard to FIGS. 3A-3B. FIG. 3A illustrates a front view of a vehicle's subframe 144 having the urethane isolation mount 140 installed therein, while FIG. 3B illustrates a top view of the subframe with the urethane isolation mount. As can be seen, the urethane isolation mount 140 has a shape that conforms to an opening of the subframe 144. In this manner, the urethane isolation mount 140 may fit snugly into the subframe 144. This prevents movement between the urethane isolation mount 140 and the subframe 144 which allow the urethane isolation mount to perform its dampening function properly. It is contemplated that the urethane isolation mount 140 may be made to extremely tight tolerances and thus may be secured by a friction fit between its surface and an opening of the subframe 144. In some embodiments, the urethane isolation mount 140 may be larger than such opening and be compressed as it is installed into the subframe 144. This helps secure the urethane isolation mount 140 in position.

The urethane isolation mount 140 may be installed by applying a force to push or press the urethane isolation mount 140 into the opening of the subframe 144. In one or more embodiments, a tool or machine may be used to apply such force. It is contemplated that the urethane isolation mount 140 may be compressed, or be provided in a compressed form. In such embodiments, the urethane isolation mount 140 may be inserted into the subframe 144 and the permitted to expand within the subframe to secure the urethane isolation mount in position.

The urethane isolation mount 140 may be inserted into the subframe 144 a predetermined distance, which may be confirmed by measurement. Alternatively or in addition, the urethane isolation mount 140 may have one or more indicators, such as markings, protrusions, or indentations to identify the distance the urethane isolation mount should be inserted. Such indicators will typically indicate a distance sufficient to properly secure the urethane isolation mount 140 within a subframe 144. It is noted that the indicator(s) could form a stop in some embodiments. For example, a protrusion, lip, or the like could extend from the body of the urethane isolation mount 140. Such a stop would physically contact a portion of the subframe 144 when and only when the urethane isolation mount 140 is inserted a proper distance. In some embodiments, this physical contact would also prevent the urethane isolation mount 140 from being inserted any further into the subframe 144.

It is noted that in some embodiments, one or more fasteners, such as screws, pins, clips, clamps, or the like could be used to secure the urethane isolation mount 140 to the subframe 144. For example, one or more screws or pins may extend from the opening of the subframe and be inserted into an opening of the urethane isolation mount 140 to hold the urethane isolation mount within the subframe 144. One or more adhesives or bonds may also or alternatively be used to secure the urethane isolation mount 140 within the subframe 144.

As can be seen from FIGS. 3A-3B, the subframe 144 holds the urethane isolation mount 140 such that the opening 204 of the mount is oriented horizontally. As discussed above, this allows the urethane isolation mount 140 to accept a horizontally oriented support step from a differential.

FIG. 3C illustrates the subframe 144 and urethane isolation mount 140 installed in a vehicle. In FIG. 3C, the subframe 144 is attached to the frame of the vehicle at the rear of the vehicle. The differential 104 may be secured by rubber mounts 108 at a front section, and by the urethane isolation mount 140 at a rear section. Namely, the differential's support stem 136 extends horizontally rearward at the back end of the differential 104. This allows the support stem 136 to engage the urethane isolation mount 140 to secure the rear of the differential 104 in position.

FIG. 3D provides a closer view of this. As can be seen, the support stem 136 may enter the opening 204 of the urethane isolation mount 140. The support stem 136 may extend at least slightly beyond the shelf or step 224 of the urethane isolation mount's opening 204. In this manner, a fastener, such as the nut 304 shown, may be tightened or secured onto the support stem 136 to secure the support stem to the urethane isolation mount 140. It is noted that a portion or all of the support stem 136 may be threaded to accomplish this.

In an alternative embodiment and as will be described further below, the opening 204 of the urethane isolation mount 140 may itself be threaded. In such embodiments, the urethane isolation mount 140 may be threaded onto the support stem 136 to secure itself to the support stem. The opening 204 may comprise a metal (or other rigid material) collar or sleeve which is threaded. In this manner, the support stem 136 could be threaded to the metal collar or sleeve of the urethane isolation mount's opening 204. In these embodiments, a separate nut or other fastener would not be required. In addition, the opening 204 may be a single width rather than having a narrower bore and a larger bore. A larger bore could be used if a nut or other fastener is still desired to further fasten the support stem 136 to the urethane isolation mount 140.

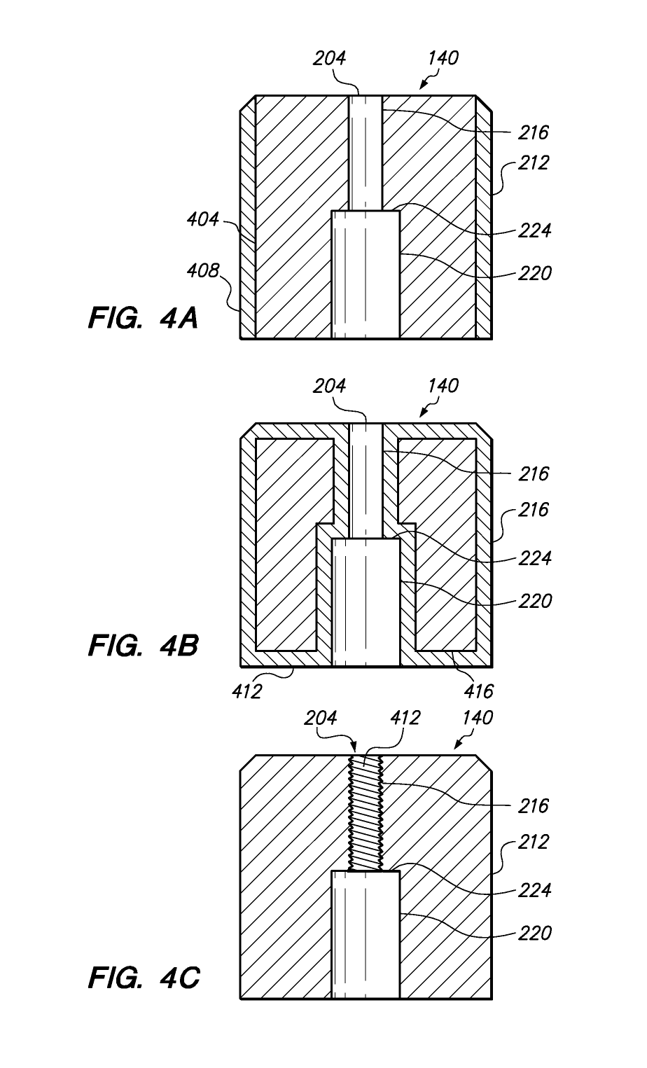

Various other embodiments of the urethane isolation mount 140 will now be described with regard to FIGS. 4A-4C, which provide cross-section views of the same. For example, referring to FIG. 4A, it is contemplated that the urethane isolation mount 140 may comprise two sections, an inner section 404 and an outer section 408. The inner section 404 may be formed from harder urethane while the outer section 408 may be formed from softer urethane. In such case, the harder urethane would be in contact with and secure the support stem of a differential. This is beneficial in that the harder urethane would be more resistant to tearing or other damage due to movement of the support stem. The softer urethane would then be adjacent the subframe. The softer urethane would be beneficial in that it provides some “give” to help dampen or isolation the differential from the remainder of the vehicle. It is noted that the outer section 408 could be harder than the inner section 404 in some embodiments. Thus the inner section 404 would provide at least some “give” to isolated the differential. It is contemplated that in such embodiments, the inner section's urethane would be sufficiently hard or durable to reliably withstand movement of the support stem.

In one or more embodiments, the outer section 408 and inner section 404 may be cylindrical in shape to provide even dampening regardless of the direction of vibration or movement of the differential. Other shapes are possible as well. For instance the inner section may be square or rectangular (or various other polygonal shapes) while the outer section is circular or another shape which conforms to a vehicle's subframe. It is contemplated that more than two sections of different urethane hardness or compositions may be used. For example, there may be three or more distinct “rings” of urethane material that form the urethane isolation mount.

Other configurations are also possible. For example, referring to FIG. 4B, the urethane isolation mount 140 may be in a shell and filler configuration. To illustrate, the urethane isolation mount 140 may have an outer shell 412 of a first harder type of urethane. This outer shell 412 may be filled with an inner filler 416 of softer urethane. This shell 412 may have a uniform thickness or may have thicker and thinner sections. For example, the outer shell 412 may be between 1 mm and 10 mm thick or thicker. Areas of the shell 412 near the support stem, such as the opening 204 may be made thicker than other areas of the shell to improve durability. The inner filler 416 of urethane would not typically be a liquid and thus would not leak. It is contemplated that the outer shell 412 of urethane could be filled with silicon in some embodiments. Since the urethane could be made more puncture resistant and durable than rubber, while remaining flexible, the risk of silicon leaking is greatly reduced, if not eliminated.

FIG. 4C illustrates an embodiment of the urethane isolation mount 140 where the narrower bore 216 is threaded. In such an embodiment, the urethane isolation mount 140 may be secured to a support stem of a differential by threading or twisting the urethane isolation mount onto the support stem. This feature does away with the need for a separate nut or other fastener, however, one may be used if desired, such as to further secure the support stem. It is contemplated that the threads of the narrower bore 216 could be formed in a harder urethane material in some embodiments. Alternatively, a threaded metal or other threaded collar may be line the narrower bore 216 to allow the urethane isolation mount 140 to be threaded onto a support stem. Though shown as extending the length of the narrower bore 216, it is contemplated that the threading of the narrower bore may extend only a portion of the length of the narrower bore in some embodiments. For instance, the threads may be positioned adjacent the shelf 224 in some embodiments, or at the opposite side of the narrower bore 216 or be centrally located in other embodiments.

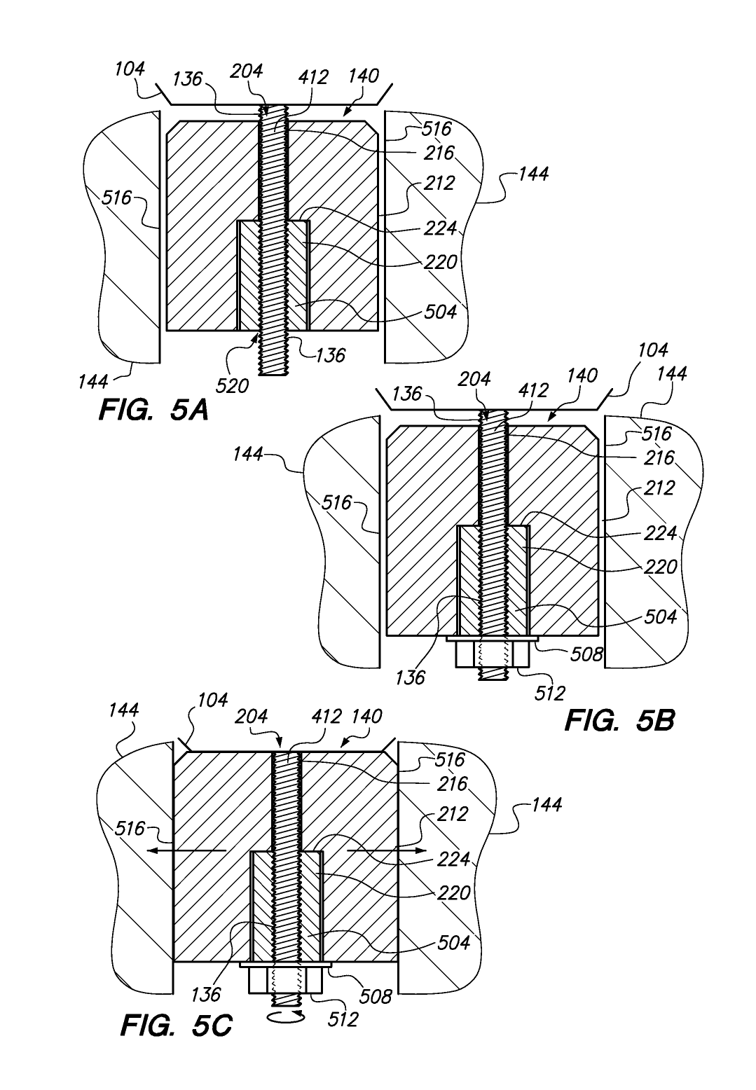

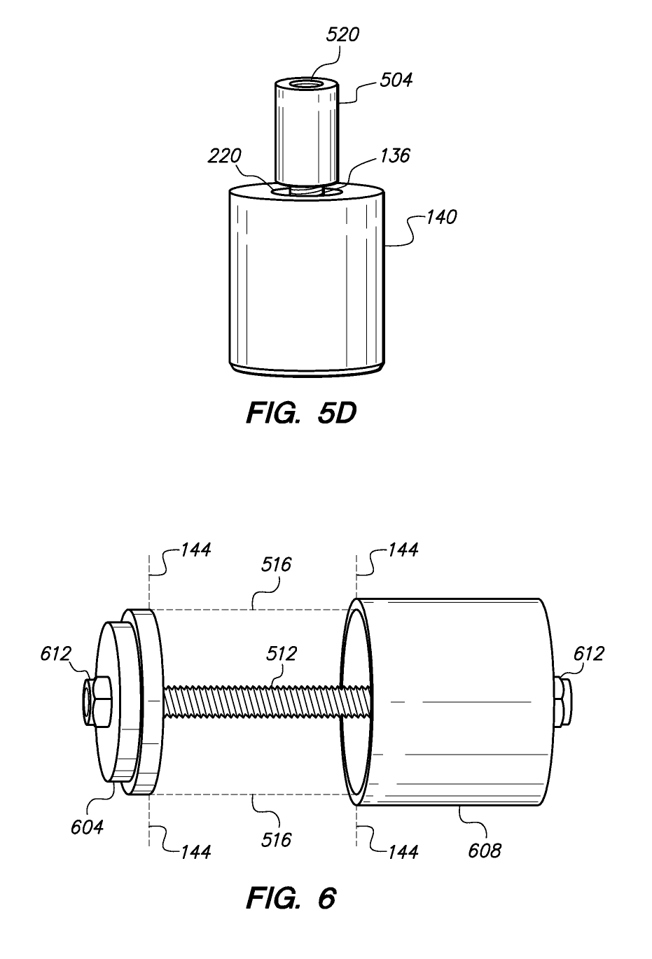

FIGS. 5A-5C illustrate another embodiment of the urethane isolation mount 140. As can be seen the urethane isolation mount 140 has been installed between walls 516 of an opening in a vehicle's subframe 144. As shown, the urethane isolation mount 140 includes an insert 504 that may be positioned within the opening 204 of the urethane isolation mount. For example, the insert 504 may be within an enlarged portion of the opening 204, such as shown. In general, the insert 504 will be a rigid material that does not easily compress under pressure. For instance, the insert 504 may be metal, plastic, or other rigid/hard material. In one embodiment, the insert 504 may be harder or less compressible than the material used to form the urethane isolation mount 140.

The insert 504 is shown in cross section in FIGS. 5A-5C. It is contemplated that the insert 504 may be shaped to conform to the opening 204 (or portion of the opening) in which it is positioned. For example, the insert 504 may be cylindrical in one or more embodiments. The insert 504 may itself have an opening 520. The opening 520 may be configured to accept the stem 136 and/or to allow the stem to extend through the insert 504. As shown for example in FIG. 5A, the stem 136 extends through the insert 504 through an opening 520 in the insert.

FIG. 5B illustrates how the urethane isolation mount 140 may be secured within the subframe 144. As can be seen a fastener 512, in the form of a nut, has been attached to the stem 136 to secure the urethane isolation mount 140. One or more load distributors or spacers 508 may be used as well, such as shown. The spacers 508 may spread the load from the fastener 512 as it is tightened on the stem 136 to secure the urethane isolation mount 140 to the subframe 144.

As can be seen from FIGS. 5A-5B, the urethane isolation mount 140 may be sized to fit within the walls 516 of an opening in a subframe 144. This allows for easy installation since there is space for urethane isolation mount 140 to fit into the subframe 144. Thus specialized tools or force can be avoided when installing the urethane isolation mount 140.

FIG. 5C illustrates that the urethane isolation mount 140 may be secured within the subframe 144. As the fastener 512 is tightened, the urethane isolation mount 140 may compress between the transmission 104 and fastener 512 and expand outward. The arrows of FIG. 5C illustrate the direction of the outward expansion. As can be seen, the urethane isolation mount 140 may then press against the walls 516 of the subframe 144, thus securing the urethane isolation mount within the subframe.

The rigidity or hardness of the insert 504 may transfer the force from the fastener 512 (as it is tightened) into the urethane isolation mount 140 thus causing the urethane isolation mount to expand outward. The spacer 508 may spread some of this force as well. As can be seen, the spacer 508 may be larger in diameter than the insert 504 thus spreading the force of the fastener 512 at a wider area in addition to that of the insert. The distribution of this force is beneficial in preventing potentially damaging point loads in helping to ensure even expansion.

FIG. 5D is a perspective view of an exemplary urethane isolation mount and insert.

FIG. 6 illustrates a tool to aid in the installation of the urethane isolation mount 140. The tool may be used to remove obstructions, such as damaged silicon-filled mounts from a subframe 144 to make room for the urethane isolation mount 140 to be installed.

The tool may comprise a presser plate 604 and a receiver cup 608 connected by a connecting rod 612. The connecting rod 612 may be threaded such that rotating it moves the presser plate 604 and receiver cup 608 closer together or farther apart (depending on the direction of rotation). As can be seen, the tool may be attached such that the presser plate 604 is on one side of a subframe 144 while the receiver cup 608 is on the other side, with the connecting rod therebetween. It is contemplated that the connecting rod 612 may first be positioned within an opening of a subframe 144 so that the presser plate 604 and/or receiver cup 608 may be subsequently attached at both sides of the subframe's opening. Then, by rotating the connecting rod 612, the presser plate 604 may be brought closer to the receiver cup 608. In one embodiment, either the presser plate 604 or the receiver cup 608 may be non-rotatably fixed to the connecting rod 612 so that rotating the connecting rod causes the presser plate and receiver cup to move relative to one another.

As rotation occurs and the presser plate 604 moves relative to the receiver cup 608, any obstructions between the walls 516 of an opening in the subframe 144 may be pushed by the presser plate into the receiver cup. It is contemplated that the connecting rod 612 may be rotated until the presser plate 604 meets or touches the receiver cup 608, thus sealing the removed obstruction(s) within the receiver cup 608. The tool may then be removed from the subframe 144, such as by disconnecting the presser plate 604 from the receiver cup 608. The presser plate 604 may be moved in a reverse direction (i.e., away from the receiver cup) and then disconnected from the connecting rod 612 in some embodiments. Alternatively or in addition, it is contemplated that the connecting rod 612 may be disconnected from the presser plate 604 and/or receiver cup 608 to allow the tool to be removed.

A urethane isolation mount 140 may then be installed within the subframe 144, such as within the newly cleared opening of the subframe. In some embodiments, the tool may be used to install the urethane isolation mount 140. This is beneficial in embodiments where the urethane isolation mount 140 has a peripheral size that snugly fits the opening of the subframe. In such cases, the urethane isolation mount 140 may have to be forced into the opening. This may be accomplished with the tool. For example, the urethane isolation mount 140 may be positioned adjacent the presser plate 604. The connecting rod 612 may pass through the opening of the urethane isolation mount from the presser plate 604. In this manner, as the presser plate 604 is moved towards the opening, it may push the urethane isolation mount into the opening to install the mount therein. It is noted that in embodiments where the urethane isolation mount 140 expands to secure itself within a subframe opening, the urethane isolation mount may be smaller than the opening to allow it to be inserted in the opening by hand or with reduced/minimal effort.

As stated, the presser plate 604 and/or receiver cup 608 may be removable from the tool such as to allow the tool to be easily and conveniently attached and removed from a subframe 144. As shown in the example of FIG. 6, the ends of the tool may comprise hexagonal caps/structures 616 that allow the connecting rod 612 to be rotated, such as by a wrench. It is contemplated that various shapes may be used. In addition, it is contemplated that the tool may have a ratcheting mechanism and/or one or more handles to allow a user to rotate the connecting rod 612.

While various embodiments of the invention have been described, it will be apparent to those of ordinary skill in the art that many more embodiments and implementations are possible that are within the scope of this invention. In addition, the various features, elements, and embodiments described herein may be claimed or combined in any combination or arrangement.

What is claimed is:

1. A urethane isolation mount for securing a differential to a subframe of a vehicle comprising:
a cylindrical body consisting of a resilient urethane material, the cylindrical body having a front end and a back end and a diameter matching the diameter of an opening in the subframe;
a beveled edge at the front end of the cylindrical body, the beveled edge at the periphery of the cylindrical body;
to an opening in the cylindrical body configured to accept a support stem extending from the differential, the opening comprising a first bore and a second bore and a step therebetween, wherein the first bore has a narrower width than the second bore; and
a rigid insert in the opening, the rigid insert configured to contact an interior portion of the cylindrical body to cause the cylindrical body to expand.

2. The urethane isolation mount of claim 1, wherein the first bore of the opening has a diameter matching the diameter of the support stem extending from the differential.

3. The urethane isolation mount of claim 1 further comprising a threaded fastener having a diameter larger than the diameter of the first bore, wherein the second bore of the opening has a diameter at least as large as the diameter of the threaded fastener.

4. The urethane isolation mount of claim 1, wherein the opening extends from the front end to the back end of the cylindrical body.

5. The urethane isolation mount of claim 1, wherein the rigid insert is in the second bore of the opening of the cylindrical body.

6. The urethane isolation mount of claim 1, wherein the first bore is threaded to accept one or more threads of the support stem of the differential.

7. The urethane isolation mount of claim 1, wherein the cylindrical body comprises at least a first and a second type of resilient urethane material, wherein the first and second type of urethane material have different hardness.

8. A urethane isolation mount assembly for securing a vehicle differential comprising:
a first resilient urethane material having a cylindrical shape, the cylindrical shape having a front end and a back end;
an opening configured to accept a support stem of the vehicle differential and extending from the front end to the back end of the first resilient urethane material, the opening comprising a first bore and a second bore and a step therebetween, wherein the first bore and the second bore have different diameters;
a threaded fastener having an inner diameter to accept a threaded portion of the support stem and an outer diameter less than the diameter of the second bore; and
a rigid insert in one of the bores of the opening, the rigid insert configured to engage and transfer pressure from the threaded fastener to the first urethane material when the threaded fastener is tightened on the support stem.

9. The urethane isolation mount assembly of claim 8 further comprising a vehicle subframe having an opening to accept the resilient urethane material, the opening of the vehicle subframe having a diameter matching a peripheral diameter of the first resilient urethane material.

10. The urethane isolation mount assembly of claim 8 further comprising a second resilient urethane material having a cylindrical shape, the second resilient urethane material having a central opening to accept the first resilient material therein, the central opening having a diameter matching a peripheral diameter of the first resilient urethane material.

11. The urethane isolation mount assembly of claim 10, wherein the first resilient urethane material is harder than the second resilient urethane material.

12. The urethane isolation mount assembly of claim 8 further comprising a beveled edge at the front end of the first resilient urethane material.

13. The urethane isolation mount assembly of claim 8, wherein the opening in the first resilient urethane material is threaded to accept a threaded portion of the support stem of the vehicle differential.

14. The urethane isolation mount assembly of claim 8 further comprising a rigid sleeve configured line the opening in the first resilient urethane material.

15. A method of securing a vehicle differential to a subframe with a urethane isolation mount comprising:
locating an opening in the subframe located at a rear end of a vehicle and adjacent the vehicle differential;
inserting a urethane isolation mount having a central opening and an outer diameter less than a diameter of the opening in the subframe into the opening of the subframe;
positioning a rigid insert within a portion of the central opening of the urethane isolation mount;
inserting a support stem of the vehicle differential into the central opening and the rigid insert, whereby the support stem extends beyond a first bore and into a second wider bore of the central opening;
inserting a fastener into the second wider bore of the central opening; and
securing the urethane isolation mount to the opening in the subframe by securing the fastener to the support stem such that the fastener presses against at least the rigid insert and causing the urethane isolation mount to expand to engage the opening in the subframe.

16. The method of claim 15 wherein the urethane isolation mount is inserted while the subframe is attached to a vehicle.

17. The method of claim 15 further comprising removing an obstruction from the opening in the subframe before inserting the urethane isolation mount by:
positioning a receiver cup at a first side of the subframe at the opening and to positioning a presser plate at a second side of the subframe at the opening; and
moving the presser plate through the opening and towards the receiver cup by rotating a connecting rod that is between the presser plate and the receiver cup, whereby the presser plate pushes the obstruction out of the opening.

18. The method of claim 14 further comprising forming the first bore and the second wider bore in the urethane isolation mount.

19. The method of claim 15 further comprising forming the urethane isolation mount from a first resilient urethane material and a second resilient urethane material, wherein the first and second resilient urethane materials have distinct hardness.

20. The method of claim 15 further comprising forming a beveled edge at one end of the urethane isolation mount.
